(19) United States
(12) Patent Application Publication
(10) Pub. No.: US 2018/0199599 A1
(43) Pub. Date: Jul. 19, 2018

(54) FLAVORED BEVERAGE ARTICLE AND METHODS OF MAKING AND USE THEREOF

(71) Applicant: Joshua Alan Randall, Central City, KY (US)

(72) Inventor: Joshua Alan Randall, Central City, KY (US)

(21) Appl. No.: 15/407,932

(22) Filed: Jan. 17, 2017

(51) Int. Cl. A23L 2/56

(52) U.S. Cl. CPC A23L 2/56; A23V 2002/00

(57) ABSTRACT

Flavored beverage articles and methods of producing and using flavored beverage articles are provided. In some embodiments, the flavored beverage article includes a covering for the outer edge of a container that is coated with food-grade adhesive and at least one edible substance, and has one or more fluted channels so that the article may attach to beverage containers, such as water bottles, beer bottles, jars and the like. The flavored beverage article may have a covering for the outer edge of a container comprising an arcuate portion and at least one fluted channel, a food-grade adhesive disposed on at least a portion of the arcuate portion of the covering for the outer edge of a container, and at least one edible substance disposed on at least a portion of the food-grade adhesive. In some embodiments, the flavored beverage article may further contain a protective outer covering.

### TECHNICAL FIELD

Embodiments of the present disclosure generally relate to flavored beverage articles and methods of making and using flavored beverage articles. Specifically, embodiments of the present disclosure relate to flavored beverage articles for the outer rim of containers, such as bottles and jars, and methods of producing and utilizing these articles to enhance the experience of drinking a beverage.

### BACKGROUND

While many individuals enjoy drinking beverages with a salted or otherwise flavored rim, it can be nearly impossible to add flavorings to the rim of a bottle, such as beer or water bottles, because of the shape and nature of the bottle opening. As bottles are packaged to be nearly full, they cannot be tipped upside down to dip into flavoring. Therefore, flavoring must be added directly to the bottle, which typically results in most, if not all, of the flavoring being undesirably added to the inside of the bottle and thus, into the contents of the bottle. To overcome these deficiencies, individuals must flavor the rim of an empty glass and transfer the beverage from the bottle to the glass in order to enjoy a flavored drink. However, not only does this inconvenient process circumvent the intended convenience of the bottle packaging but it also requires excess equipment and additional steps to impart flavorings onto bottled packaging.

### SUMMARY

Accordingly, an ongoing need exists to provide a solution to impart flavorings to bottled beverages without the hassle and mess of these conventional methods.

The present embodiments address these needs by providing a flavored beverage article and methods of using flavored beverage articles to impart flavoring to the opening or outer rim of containers, such as bottles.

Embodiments of the present disclosure relate to methods of producing a flavored beverage article by at least partially coating an arcuate portion of a covering for an outer edge of a container with a food-grade adhesive and at least partially coating the food-grade adhesive with at least one edible substance to produce the flavored beverage article.

Further embodiments of the present disclosure relate to flavored beverage articles having a covering for the outer edge of a container comprising an arcuate portion and at least one fluted channel, a food-grade adhesive disposed on at least a portion of the arcuate portion of the covering for the outer edge of a container, and at least one edible substance disposed on at least a portion of the food-grade adhesive.

Still further embodiments of the present disclosure relate to methods of using a flavored beverage article by placing a flavored beverage article on the outer edge of a container, securing the flavored beverage article to the outer edge of the container, and removing a protective outer covering from the flavored beverage article. The flavored beverage article may include a covering for the outer edge of a container that has an arcuate portion and at least one fluted channel, a food-grade adhesive disposed on at least a portion of the arcuate portion of the flavored beverage article, at least one edible substance disposed on at least a portion of the food-grade adhesive, and a protective outer covering.

Additional features and advantages of the described embodiments will be set forth in the detailed description which follows, and in part will be readily apparent to those skilled in the art from that description or recognized by practicing the described embodiments, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, in which:

FIG. 1 is a schematic depiction of a method of using a flavored beverage article on a container according to embodiments shown and described herein;

FIG. 2 is a schematic depiction of a method of producing a flavored beverage article according to embodiments shown and described herein;

FIG. 3A is a schematic depiction of the threaded channels of a flavored beverage article according to embodiments shown and described herein;

FIG. 3B is a schematic depiction of the threaded channels of another flavored beverage article according to embodiments shown and described herein;

FIG. 3C is a schematic depiction of the threaded channels of yet another flavored beverage article according to embodiments shown and described herein;

FIG. 4 is a schematic depiction of a container comprising a flavored beverage article utilizing two edible substances according to embodiments shown and described herein; and

FIG. 5 is a schematic depiction of another container comprising a flavored beverage article according to embodiments shown and described herein.

### DETAILED DESCRIPTION

Embodiments of the present disclosure are directed to flavored beverage articles and methods of making and using flavored beverage articles. In some embodiments, the flavored beverage article includes a covering for the outer edge of a container that is coated with food-grade adhesive and at least one edible substance, and has one or more fluted channels so that the article may attach to beverage containers, such as water bottles, beer bottles, jars and the like.

The following description of the embodiments is exemplary and illustrative in nature and is in no way intended to be limiting it its application or use. Specific embodiments will be described with references to the figures. Whenever possible, the same reference numerals will be used throughout the drawings to refer to the same or like parts. As used throughout this disclosure, the singular forms “a,” “an” and “the” include plural referents unless the context clearly dictates otherwise. Thus, for example, reference to “a” component includes aspects having two or more such components, unless the context clearly indicates otherwise.

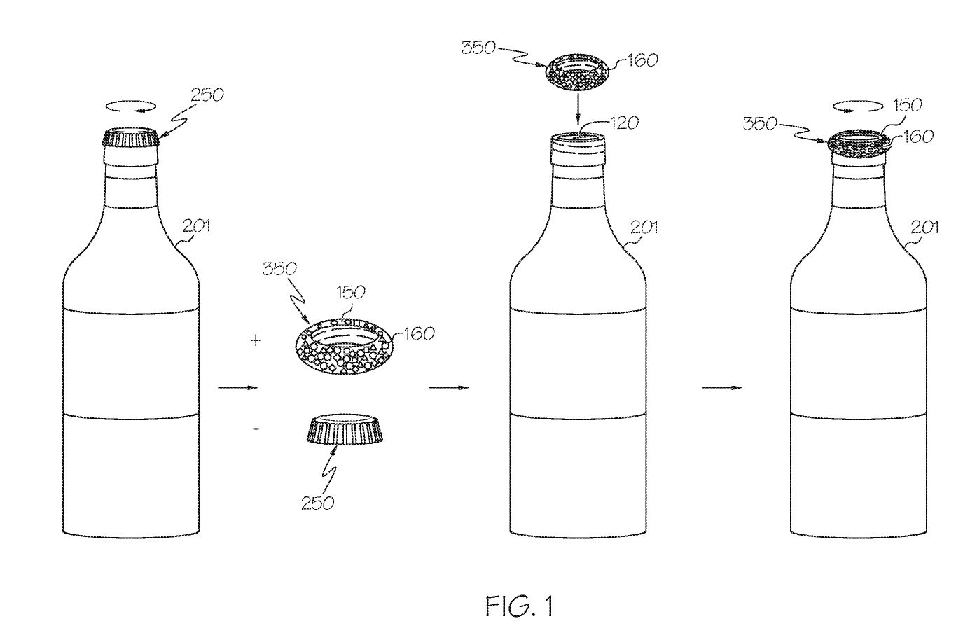

FIG. 1 schematically portrays one method of using a flavored beverage article 350 of the present disclosure to improve a beverage-drinking experience. FIG. 1 shows a container 201, depicted as a beer bottle. However, the container 201 may be, among other things, a bottle, a jar, a re-sealable container, or other such items. The container 201, in some embodiments, may be a beer bottle, including glass, metal or plastic beer bottles, such as growlers, pints, long-neck bottles, 7 ounce (oz), 16 oz, 22 oz, 40 oz or other sized bottles. The container 201 may be a water bottle, including plastic water bottles in any size, including 16.9 oz, 8 oz, and 12 oz prepackaged or reusable water bottles. The container 201 may be an aluminum bottle or another metal-based water bottle in any size or shape. The container 201 may be a soda bottle, including plastic, metal, and glass bottles, such as, for instance, Coca-Cola® glass bottles, 16.9 oz bottles, a 2-liter bottle, and the like. The container 201 may be bottle of wine (plastic, glass or metal), a bottle of liquor or spirits (plastic, glass or metal) or a jar, (plastic, glass or metal) including Ball and Mason jars. It should be understood that this is a non-exhaustive list and other containers 201 are contemplated as suitable for use in the present embodiments.

In FIG. 1, the container 201 is shown as a beer bottle with a traditional crown twist-off closure as a pre-existing cap 250. Once the pre-existing cap 250 is removed, a flavored beverage article 350 of the present disclosure may be placed on top of the container 201. The container 201 depicted in FIG. 1 has a bottle-necked opening with at least one threaded channel 120 on the outermost edge of the opening of the container 201. These outer threaded channels 120 may exist to allow the pre-existing cap 250 to twist on and off the container 201 to seal the container 201 and preventing the beverage from leaking. Other containers 201 may have pre-existing caps 250 that, for instance, pop, snap, or push and pull on and off of the container 201.

The flavored beverage article 350 of the present disclosure, unlike the pre-existing cap 250, may have an inner opening that allows the contents of the container 201 to freely flow out of the container 201. This may allow the user to drink from the container 201 without removing the flavored beverage article 350, as the flavored beverage article 350 may be used to impart flavoring onto the beverage or food-item in the container 201 to improve the drinking experience. In some embodiments, the flavored beverage article 350 may be a ring or a rim having an arcuate portion. As used herein, “arcuate” refers a curved surface extending in an arc, such as the curvature of a ring, a rim, or a cylindrical surface.

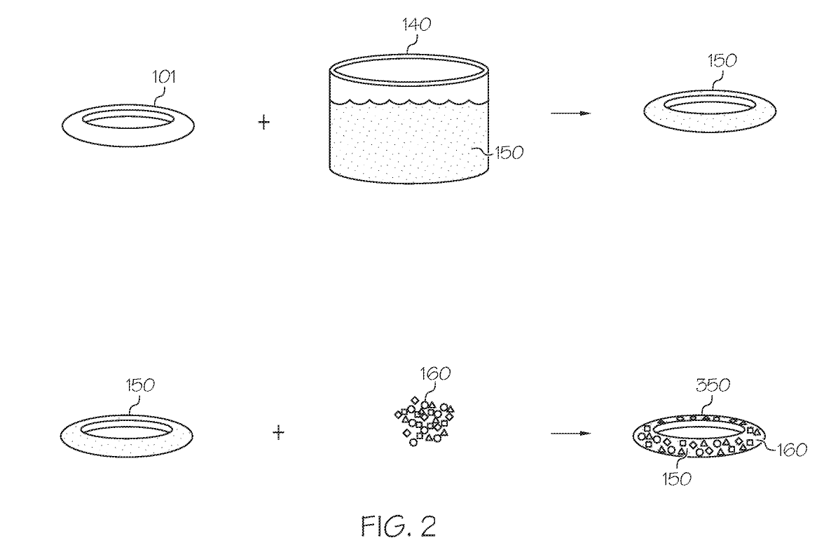

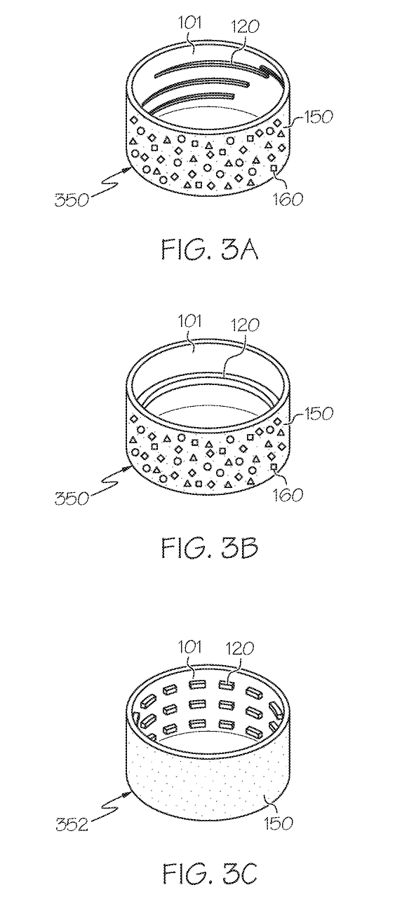

As shown in FIG. 1, methods of using the flavored beverage article 350 to enhance the experience of drinking a beverage in some embodiments, may involve first untwisting and removing the pre-existing cap 250. Next, a flavored beverage article 350 of the present disclosure may be placed over of the opening of a container 201 around the outer edge of the container opening. As will be discussed in detail with reference to FIG. 2, the flavored beverage article 350 may contain a food-grade adhesive 150 that may be coated with an edible substance 160. The flavored beverage article 350 may be twisted onto the container 201 using the at least one threaded channel 120 (discussed in detail with reference to FIGS. 3A, 3B and 3C) to secure the flavored beverage article 350 to the container 201.

FIG. 2 is a schematic view of one embodiment of a method for producing a flavored beverage article 350. In the method shown in FIG. 2, an uncoated covering 101 is coated with a food-grade adhesive 150 on its arcuate surface. The arcuate surface of the flavored beverage article 350 refers to the outer portion of the article, excluding any threaded channels 120 (as shown in FIGS. 3A, 3B and 3C) positioned on the inner portion of the article. The arcuate portion may be, for instance, curved, rounded, concave, convex, flat, or cylindrical and may include the top, bottom and side portions of the uncoated covering 101. In some embodiments, the arcuate portion may only include the top and side portions of the uncoated covering 101, or may just include only the side portions of the uncoated covering 101.

The uncoated covering 101 may be a covering for an outer edge of the container 201, such as a rim, band, ring, cap with an opening, or other closure device with an at least partially open center cavity for a container 201, such as a bottle or jar, as previously described. The uncoated covering 101 may be made of plastic, including but not limited to high density polyethylene (HDPE), low density polyethylene (LDPE), polyethylene terephthalate (PET), polyester, polyvinyl chloride (PVC)(including suspensions of PVC commercially known as “Plastisol”), polycarbonate (PC), polypropylene (PP), polystyrene, fluorine-treated HDPE, post consumer resin (PCR), K-Resin (a styrene derivative), bioplastic, or combinations thereof. In some embodiments, the uncoated covering 101 may be comprised of metal (including steel and aluminum), glass, porcelain, clay, organic materials, or combinations thereof. In embodiments in which the uncoated covering 101 is made of metal, the metal may be coated with anti-corrosive coatings, and may be plated in chromeplate or tinplate. The uncoated covering 101 may include thermoset or phenolic resin, such as urea and melamine resins, and may contain a synthetic resin, such as polyoxybenzylmethylenglycolanhydride, commercially available as “Bakelite”. The uncoated covering 101 in some embodiments may include a liner material. The liner material may be foamed polyethylene, such as a foam-backed polytetrafluoroethylene (PTFE) or foamed low-density polyethylene, commercially known as “F-217.” The liner material may include pulp, vinyl, rubber, pressure-sensitive liners, such as those commercially known as “PS 22,” polyseal cone liners, or combinations of any of these.

Referring again to the method for producing a flavored beverage article 350 shown in FIG. 2, the uncoated covering 101 may undergo a coating step in which at least a portion of the uncovered covering 101 is coated with a food-grade adhesive 150. As used herein, “food-grade adhesive” refers to a substance that has, or is reasonably expected to have approval by the U.S. Food and Drug Administration (FDA) for use as a food additive (such as an indirect food additive) that is sticky, tacky, or otherwise has the ability to adhere or bind two or more objects. The food-grade adhesive 150 may be a liquid or a solid, or may transition from a liquid solution to a solid upon application to the uncoated covering 101.

The food-grade adhesive 150 is shown housed in a container 140, as the food-grade adhesive 150 may, in some embodiments, be a sticky liquid or a semi-liquid (viscous and almost solid-like) solution. The food-grade adhesive 150 may be any adhesive known in the food service industry that is safe for human consumption. In some embodiments, the food-grade adhesive 150 may include syrup, honey, corn syrup, simple syrup, gelatin, xanthan gum dissolved in water, agar dissolved in water, guar gum dissolved in water, fructose, or combinations thereof. The food-grade adhesive 150 may be used to adhere one or more edible substances 160 to the uncoated covering 101 or may be used alone to impart flavoring to the uncoated covering 101, particularly in embodiments in which the food-grade adhesive 150 includes syrup, honey, corn syrup, simple syrup, fructose, and other adhesives having an appealing taste. In other embodiments, such as the method shown in FIG. 1, after the uncoated covering 101 is coated with a food-grade adhesive 150 to at least partially coat the uncoated covering 101. The food-grade adhesive 150 may be at least partially coated with an edible substance 160 to result in a flavored beverage article 350.

The edible substance 160 may be any substance capable of imparting a desired flavor or texture to the food-grade adhesive 150. The edible substance 160 may be a flavoring, a food-product, a powder, a colorant, a spice, or combinations of these. For instance, non-limiting examples of possible edible substances 160 may include salt, flavored salt, margarita salt, rimming salt, sugar, lemon flavoring, lime flavoring, orange flavoring, fruit flavoring, jalapeno flavoring, nutmeg, cinnamon, coconut, bacon, lemon sugar, lime sugar, lemon salt, lime salt, jalapeno salt, cinnamon sugar, candy, sprinkles, cocoa powder, powdered sugar, chili powder, herbs, spices, artificial flavoring, natural flavoring, artificial colorants, natural colorants, or combinations thereof. It should be understood that any edible substance 160 may be used to coat the food-grade adhesive 150. The substance should be edible or otherwise safe for human consumption, as the flavored beverage article 350 may be used to cover the outer edge of containers used for food or beverage purposes.

FIGS. 3A, 3B and 3C are schematic depictions of embodiments of flavored beverage articles 350 to further illustrate the structural features of the flavored beverage articles 350. As shown in FIGS. 3A and 3B, the uncoated covering 101 (and thus the flavored beverage article 350) may, in some embodiments, be a full, complete circle, such as an unbroken ring. However, as shown in FIG. 3C, in other embodiments the uncoated covering 101 (and thus the flavored beverage article 350) or may be an incomplete circle, such as a broken ring. The broken ring of the flavored beverage article 350 depicted in FIG. 3C may allow the flavored beverage article 350 to be adjustable so as to fit a variety of sizes of container 201 openings and to allow the flavored beverage article 350 to be more easily placed on top of the opening of the container 201. A flavored beverage article 350 may be particularly useful as a broken ring in embodiments utilizing threaded channels 120 that do not screw or twist onto the container 201 but rather snap and pop into place, as previously described. In these embodiments, the flavored beverage article 350 may include only one threaded channel 120 extending around the inner portion of the uncoated covering 101 as a lip. In other embodiments, two or more or three or more threaded channels 120 may extend around the uncoated covering 101 as a lip that snaps or pushes onto the container 201 to secure the flavored beverage article 350 in place.

While FIGS. 3A, 3B and 3C are depicted as circular rings, it should be understood that any shape may be suitable for use as a flavored beverage article 350 to accommodate the opening of a container 201. In some embodiments, the flavored beverage article 350 may have a square, rectangular, ellipse, triangular, or hexagonal, octagonal, or other shape.

In some embodiments, the length or diameter of the flavored beverage article 350, (whether the flavored beverage article 350 is a broken or unbroken embodiment), as measured from the opening across the inside of the uncoated covering 101 (threaded channel 120 included, if present) may be from 5 millimeters (mm) to 100 mm. The length or diameter of the flavored beverage article may be from 5 mm to 50 mm, from 5 mm to 30 mm, from 10 mm to 50 mm, from 10 mm to 30 mm, from 15 mm to 50 mm, from 15 mm to 30 mm, from 20 mm to 50 mm, or from 20 mm to 30 mm. The diameter of the flavored beverage article 350 may equivalent to the inner diameter of the pre-existing cap 250, which may be slightly larger than the outer diameter at the opening of the container 201. The flavored beverage article 350 have a diameter such that it fits a container 201 having a pre-existing cap 250 size of 26 mm, or 28 mm, or 33 mm, or 38 mm, or 43 mm, or 48 mm. The flavored beverage article 350 have a diameter such that it fits a container 201 having a pre-existing cap 250 size of from 18 to 120 mm, or 18 to 28 mm, or 13 to 33 mm. These sizes may be an approximation of the original cap diameter and it should be understood that any measurement may be within a margin of error of about ±0.75 mm. The flavored beverage article 350 may have any suitable height, length, and width, depending on the desired application and depending on the corresponding container 201.

The uncoated covering 101 may have at least one threaded channel 120, which may be used to secure the covering to the outer edge of the container 201. The threaded channel 120 may be in accordance with any known thread specifications for containers, such as bottles. For instance, the threaded channel 120 may be in accordance with any of the specifications listed by the International Society of Beverage Technologists Threadspecs Downloads, available at http://www.bevtech.org/threadspecs-downloads.asp, incorporated by reference herein in its entirety. In some embodiments, the uncoated covering 101 may have a threaded channel 120 comprising three leads in a right-handed threading, spaced approximately 120° apart with a 6.35 mm travel per turn. It should be understood that varying threaded channel 120 configurations may be utilized depending on the desired application and any suitable embodiment may be used for the threaded channel 120.

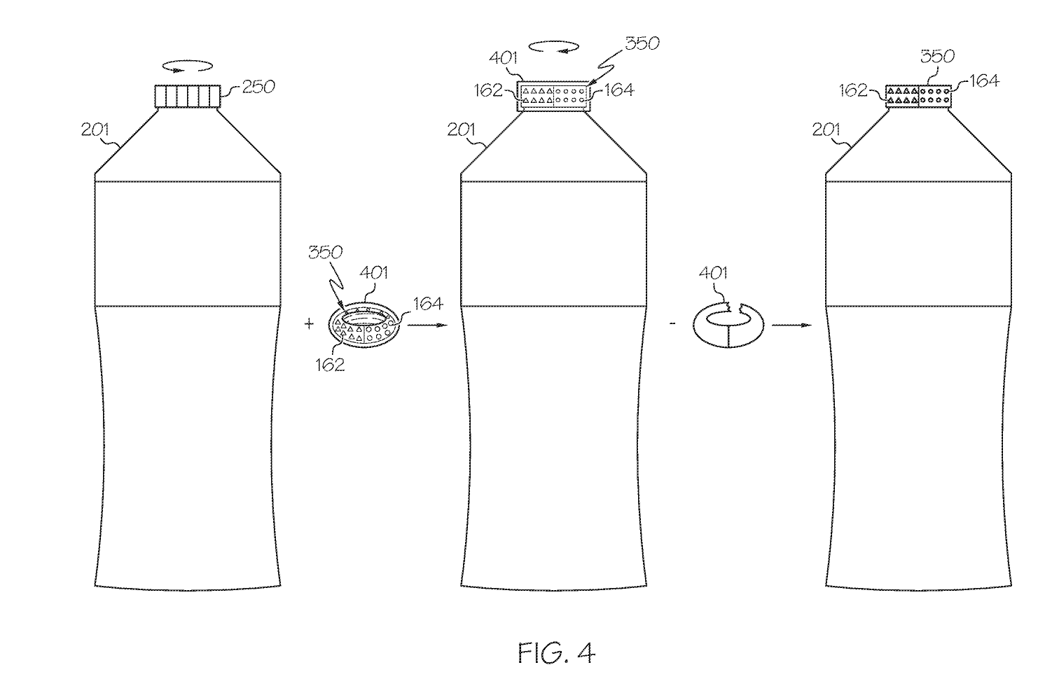

Referring now to FIG. 4, in some embodiments, the flavored beverage article 350 may contain two or more edible substances 160, such as a first edible substance 162 and a second edible substance 164. The flavored beverage article 350 may contain any number of edible substances 160 or combinations of edible substances 160 to suit the particular applications of use. In FIG. 4, the container 201 is a pre-packaged water bottle with a twist-off pre-existing cap 250 that is replaced with a flavored beverage article 350. However, as previously described, the container 201 may be any suitable bottle, jar, or other vessel. As shown in FIG. 4, the flavored beverage article 350 may be twisted onto the outer edge of the container 201, securing it in place. In other embodiments, the flavored beverage article 350 may be snapped or pushed into place to secure the flavored beverage article 350 onto the outer edge of the container 201.

As shown in FIG. 4, embodiments of the flavored beverage article 350 may include two or more, three or more, or four or more edible substances 160. In some embodiments, the flavored beverage article 350 may include a first edible substance 162 and a second edible substance 164 selected from the group consisting of salt, flavored salt, margarita salt, rimming salt, sugar, lemon flavoring, lime flavoring, orange flavoring, fruit flavoring, jalapeno flavoring, nutmeg, cinnamon, coconut, bacon, lemon sugar, lime sugar, lemon salt, lime salt, jalapeno salt, cinnamon sugar, candy, sprinkles, cocoa powder, powdered sugar, chili powder, herbs, spices, artificial flavoring, natural flavoring, artificial colorants, natural colorants, and combinations and mixtures thereof. It should be understood that other similar edible substances 160 are contemplated and any food-grade flavorings, syrups, spices, minerals, candies, or other food products may be used.

As shown in FIG. 4, in some embodiments, the flavored beverage article 350 may be partially or fully surrounded by a protective outer covering 401. The protective outer coating 401 may at least partially surround the flavored beverage article 350 to protect the edible substance 160, the food-grade adhesive 150, or both.

In some embodiments, the protective outer coating 401 may protect the user's hands from contacting the first edible substance 162, the second edible substances 164, and the food-grade adhesive 150 that are disposed on the flavored beverage article 350. The method may include securing the flavored beverage article 350 to the outer edge of the container 201 and removing the outer protective covering 401 from the flavored beverage article 350. In some embodiments, removing the protective outer covering 401 may include peeling off the protective outer covering 401 once the flavored beverage article 350 is secured to the outer edge of the container 201.

The protective outer covering 401 may be any suitable food-safe covering, such as those used in food packaging products. The protective outer covering 401 may include but is not limited to plastic and metallized films. The protective outer covering 401 may include one or more of polyethylene (PE), polypropylene (PP), polyethylene terephthalate (PET), cellulosic, polycarbonate, polyamide (PA), polyvinylidene chloride (PVDC), PVDC coated polyethylene terephthalate, PVDC coated polypropylene, metallized polyethylene terephthalate, metallized polypropylene, metallized foil, aluminum, nylon, vinyl acetate, vinyl alcohol, vinyl chloride, polyester, laminates of polyester film, polyvinylidene chloride(saran)-polyethylene, nylon-saran-polyethylene, polyester-saran-polyethylene, cellophane-saran-polyethylene, combinations thereof, and other similar substrates.

In some embodiments, the protective outer covering 401 may be perforated in some areas or may have a means of easy removal. The protective outer covering 401 may surround the flavored beverage article 350 until the flavored beverage article 350 is securely in place on top of the outer edge of the container 201. Upon positioning and securing the flavored beverage article 350, the protective outer covering 401 may be removed and discarded, resulting in the container 201 having a flavored beverage article 350 having the first edible substance 162, the second edible substance 164, and the food-grade adhesive 150 securely intact. As shown in FIG. 4, in some embodiments, the protective outer covering 401 may be partitioned so as to separate the first edible substance 162 from the second edible substance 164 to prevent them from undesirably mixing before placement on top of the container 201.

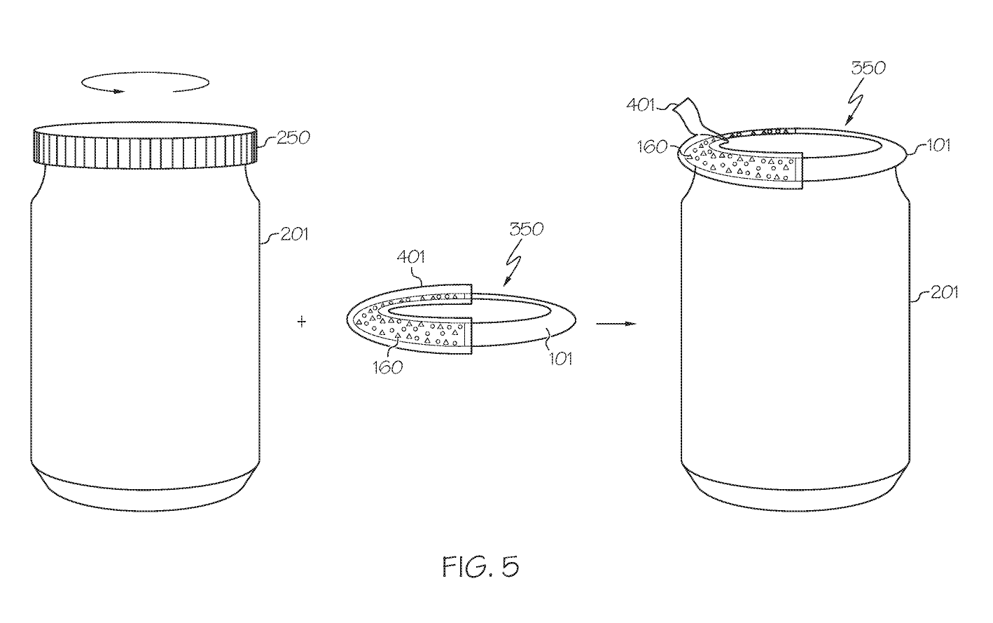

Referring now to FIG. 5, another embodiment of the protective outer covering 401 is shown. FIG. 5 is a schematic depiction of another container 201 comprising a flavored beverage article 350, according to embodiments shown and described herein in which the flavored beverage article 350 contains an uncoated covering 101 that is partially uncoated or otherwise unexposed. Said another way, the flavored beverage article 350 depicted by FIG. 5 is only partially coated by both the food-grade adhesive 150 and the edible substance 160.

FIG. 5 shows an embodiment of the disclosure in which the container 201 is a jar. The jar may be comprised of glass, plastic, or ceramic and may be used for food, food products, or beverages. The jar may be a Ball jar, a Mason jar, or any other type of jar known in the industry. The flavored beverage article 350 shown in FIG. 5 includes a protective outer covering 401 that only partially surrounds the flavored beverage article 350.

As shown in FIG. 5, in some embodiments, the flavored beverage article 350 may only be partially coated with the food-grade adhesive 150, the edible substance 160, or both. The food-grade adhesive 150, the edible substance 160, or both, may at least partially cover the uncoated covering 101 such that about 50 weight percent (wt %) of the surface area of the arcuate portion of the uncoated covering 101 is not coated by the food-grade adhesive 150 and the edible substance 160 or is otherwise uncovered and exposed. In some embodiments, about 25 wt %, about 30 wt %, about 45 wt %, about 75 wt %, or about 10 wt % of the surface area of the arcuate portion of the uncoated covering 101 may not coated by the food-grade adhesive 150 and the edible substance 160 or may be otherwise uncovered and exposed.

The flavored beverage article 350 of FIG. 5 is shown with about 50 wt % of the surface area of the arcuate portion of the uncoated covering 101 substantially uncoated by the food-grade adhesive 150 and the edible substance 160 such that about half of the flavored beverage article 350 contains the edible substance 160 and about half of the flavored beverage article 350 is the uncoated covering 101. As used herein, “substantially uncoated” means that the uncoated portion comprises less than or equal to 10 wt % (such as less than or equal to 8 wt %, less than or equal to 5 wt %, and less than or equal to 3 wt %) of a coating, such as the food-grade adhesive 150 and the edible substance 160.

Utilizing embodiments of the flavored beverage article 350 in which the uncoated covering 101 is at least partially exposed may allow the user to customize the flavored drinking experience. The user may elect to drink from the flavored side of the flavored beverage article 350, from the unflavored side (the uncoated covering 101) of the flavored beverage article 350, or a combination of both. Similarly, the user may elect to drink from a partially flavored and partially unflavored portion of the flavored beverage article 350 to reduce the intensity of the edible substance 160.

It should be apparent to those skilled in the art that various modifications and variations may be made to the embodiments described within without departing from the spirit and scope of the claimed subject matter. Thus, it is intended that the specification cover the modifications and variations of the various embodiments described within provided such modification and variations come within the scope of the appended claims and their equivalents.

Having described the subject matter of the present disclosure in detail and by reference to specific embodiments of any of these, it is noted that the various details disclosed within should not be taken to imply that these details relate to elements that are essential components of the various embodiments described within, even in cases where a particular element is illustrated in each of the drawings that accompany the present description. Further, it should be apparent that modifications and variations are possible without departing from the scope of the present disclosure, including, but not limited to, embodiments defined in the appended claims. More specifically, although some aspects of the present disclosure are identified as particularly advantageous, it is contemplated that the present disclosure is not necessarily limited to these aspects.

1. A method of producing a flavored beverage article; the method comprising:
at least partially coating an arcuate portion of a covering for an outer edge of a container with a food-grade adhesive, wherein the arcuate portion includes the side portions of the covering; and
at least partially coating the food-grade adhesive with at least one edible substance to produce the flavored beverage article, wherein the flavored beverage article may be twisted onto a container using at least one fluted channel.

2. The method of claim 1, wherein the container is a bottle or jar.

3. The method of claim 1, wherein the edible substance is selected from the group consisting of salt, flavored salt, margarita salt, rimming salt, sugar, lemon flavoring, lime flavoring, orange flavoring, fruit flavoring, jalapeno flavoring, nutmeg, cinnamon, coconut, bacon, lemon sugar, lime sugar, lemon salt, lime salt, jalapeno salt, cinnamon sugar, candy, sprinkles, cocoa powder, chili powder, herbs, spices, artificial flavoring, natural flavoring, artificial colorants, natural colorants, or combinations thereof.

4. The method of claim 1, wherein the food-grade adhesive is selected from the group consisting of syrup, honey, corn syrup, simple syrup, gelatin, xanthan gum dissolved in water, agar dissolved in water, guar gum dissolved in water, fructose, or combinations thereof.

5. A flavored beverage article comprising:
a covering for the outer edge of a container comprising an arcuate portion and at least one fluted channel;
a food-grade adhesive disposed on at least a portion of the arcuate portion of the covering for the outer edge of a container, wherein the arcuate portion includes the side portions of the covering; and
at least one edible substance disposed on at least a portion of the food-grade adhesive; wherein the flavored beverage article is twisted onto the container using the at least one fluted channel.

6. The flavored beverage article of claim 5, wherein the container is a bottle or jar.

7. The flavored beverage article of claim 5, wherein the edible substance is selected from the group consisting of salt, flavored salt, margarita salt, rimming salt, sugar, lemon flavoring, lime flavoring, orange flavoring, fruit flavoring, jalapeno flavoring, nutmeg, cinnamon, coconut, bacon, lemon sugar, lime sugar, lemon salt, lime salt, jalapeno salt, cinnamon sugar, candy, sprinkles, cocoa powder, chili powder, herbs, spices, artificial flavoring, natural flavoring, artificial colorants, natural colorants, and combinations thereof.

8. The flavored beverage article of claim 5, wherein the food-grade adhesive is selected from the group consisting of syrup, honey, corn syrup, simple syrup, gelatin, xanthan gum dissolved in water, agar dissolved in water, guar gum dissolved in water, fructose, and combinations thereof.

9. (canceled)

10. (canceled)

11. (canceled)

12. (canceled)

13. The flavored beverage article of claim 5, wherein the edible substance is disposed on less than or equal to half of the arcuate portion of the covering for the outer edge of a container.

14. The flavored beverage article of claim 5, wherein two or more edible substances are disposed on the food-grade adhesive solution.

15. The flavored beverage article of claim 5, wherein the arcuate portion of the covering for the outer edge of a container is an unbroken ring.

16. The flavored beverage article of claim 5, wherein the arcuate portion of the covering for the outer edge of a container is a broken ring.

17. The flavored beverage article of claim 5, further comprising a protective outer covering.

18. The flavored beverage article of claim 17, wherein the protective outer covering comprises a member selected from the group consisting of polyethylene (PE), polypropylene (PP), polyethylene terephthalate (PET), cellulosic, polycarbonate, polyamide (PA), PVDC coated polyethylene terephthalate, PVDC coated polypropylene, metallized polyethylene terephthalate, metallized polypropylene, metallized foil, aluminum, nylon, vinyl acetate, vinyl alcohol, vinyl chloride, polyester, laminates of polyester film, polyvinylidene chloride(saran)-polyethylene, nylon-saran-polyethylene, polyester-saran-polyethylene, cellophane-saran-polyethylene and combinations thereof.

19. A method of using a flavored beverage article, the method comprising:
placing a flavored beverage article on the outer edge of a container, wherein the flavored beverage article comprises
a covering for the outer edge of a container comprising an arcuate portion and at least one fluted channel, wherein the arcuate portion includes the side portions of the covering,
a food-grade adhesive disposed on at least a portion of the arcuate portion of the flavored beverage article,
at least one edible substance disposed on at least a portion of the food-grade adhesive, and
a protective outer covering;
securing the flavored beverage article to the outer edge of the container by twisting the flavored beverage article onto the outer edge of the container using the at least one fluted channel; and
removing the protective outer covering from the flavored beverage article.

20. The method of claim 19, wherein the protective outer covering comprises a member selected from the group consisting of polyethylene (PE), polypropylene (PP), polyethylene terephthalate (PET), cellulosic, polycarbonate, polyamide (PA), PVDC coated polyethylene terephthalate, PVDC coated polypropylene, metallized polyethylene terephthalate, metallized polypropylene, metallized foil, aluminum, nylon, vinyl acetate, vinyl alcohol, vinyl chloride, polyester, laminates of polyester film, polyvinylidene chloride(saran)-polyethylene, nylon-saran-polyethylene, polyester-saran-polyethylene, cellophane-saran-polyethylene, and combinations thereof.

21. The flavored beverage article of claim 5, wherein less than or equal to 3 weight percent (wt %) of the covering is substantially uncoated by the food-grade adhesive and the edible substance.

22. The flavored beverage article of claim 5, wherein about 10 weight percent (wt %) of the surface area of the arcuate portion of the covering is not coated by the food-grade adhesive and the edible substance.

23. The flavored beverage article of claim 5, wherein the covering comprises high density polyethylene (HDPE), polyethylene terephthalate (PET), polyester, polyvinyl chloride (PVC), polycarbonate (PC), polypropylene (PP), polystyrene, fluorine-treated HDPE, post-consumer resin (PCR), K-Resin, metal, glass, porcelain, or combinations thereof.

24. The flavored beverage article of claim 17, wherein the protective coveting comprises perforations for easy removal.
